(19) United States
(12) Patent Application Publication
(10) Pub. No.: US 2015/0117150 A1
(43) Pub. Date: Apr. 30, 2015

(54) IN-PHASE PRECURSOR SEISMIC SWEEP

(71) Applicant: WesternGeco L.L.C., Houston, TX (US)

(72) Inventor: Claudio Bagaini, Cottenham (GB)

(21) Appl. No.: 14/520,066

(22) Filed: Oct. 21, 2014

Related U.S. Application Data
(60) Provisional application No. 61/895,276, filed on Oct. 24, 2013.

(51) Int. Cl. G01V 1/04; G01V 1/28

(52) U.S. Cl. CPC G01V 1/04; G01V 1/28
USPC 367/37

(57) ABSTRACT

Various implementations described herein are directed to a method of performing a seismic survey operation. The method may include deploying two seismic sources. The method may include using the two seismic sources to perform a simultaneous in-phase precursor sweep. The method may also include using the two seismic sources to perform a simultaneous out-of-phase cascaded sweep.

### CROSS-REFERENCE TO RELATED APPLICATIONS

This application claims the benefit of U.S. Provisional Patent Application Ser. No. 61/895,276, filed Oct. 24, 2013, titled Vibroseis Data Between Source Lines, and the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

In the oil and gas industry, geophysical prospecting techniques are commonly used to aid in the search for and evaluation of subterranean hydrocarbon deposits. Generally, a seismic energy source is used to generate a seismic signal that propagates into the earth and is at least partially reflected by subsurface seismic reflectors (i.e., interfaces between underground formations having different acoustic impedances). The reflections are recorded by seismic detectors located at or near the surface of the earth, in a body of water, or at known depths in boreholes, and the resulting seismic data may be processed to yield information relating to the location of the subsurface reflectors and the physical properties of the subsurface formations.

The seismic signal generated by a seismic vibrator is a controlled wavetrain (i.e., a sweep), which is applied to the surface of the earth or in the body of water or in a borehole. In seismic surveying on land using a vibrator, to impart energy into the ground in a swept frequency signal, the energy is typically imparted using a hydraulic drive system to vibrate a large weight (the reaction mass) up and down. The reaction mass is coupled to a baseplate in contact with the earth and through which the vibrations are transmitted to the earth. The baseplate also supports a large fixed weight, known as the hold-down weight. Typically, a sweep is a sinusoidal vibration of continuously varying frequency, increasing or decreasing monotonically within a given frequency range. The frequency may vary linearly or nonlinearly with time.

### SUMMARY

Described herein are implementations of various technologies for a method of performing a seismic survey operation. The method may include deploying two seismic sources separated by a distance. The method may include using the two seismic sources to simultaneously emit an in-phase first seismic sweep ranging from a minimum frequency to a cutoff frequency, wherein the cutoff frequency is calculated based on the distance. The method may also include using the two seismic sources to simultaneously emit an out-of-phase second seismic sweep ranging from the cutoff frequency to a maximum frequency.

Described herein are also implementations of various technologies for a non-transitory computer-readable medium having stored thereon computer-executable instructions which, when executed by a computer, cause the computer to perform various actions. The actions may include causing a first and second seismic vibrator to emit simultaneously an in-phase first seismic sweep ranging from a minimum frequency to a cutoff frequency. The actions may include causing the first and second seismic vibrator to emit simultaneously an out-of-phase second seismic sweep ranging from the cutoff frequency to a maximum frequency less than or equal to twice the cutoff frequency. The actions may include acquiring a first dataset attributable to the first seismic vibrator. The actions may include acquiring a second dataset attributable to the second seismic vibrator. The actions may also include processing the first and second datasets.

Described herein are also implementations of various technologies for a method of performing a seismic survey operation. The method may include deploying two seismic sources. The method may include using the two seismic sources to perform a simultaneous in-phase precursor sweep. The method may also include using the two seismic sources to perform a simultaneous out-of-phase cascaded sweep.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates elements of a vibroseis seismic survey in connection with implementations of various techniques described herein.

FIG. 2 illustrates a diagram of a seismic survey in connection with implementations of various techniques described herein.

FIG. 3 is a flow diagram of a method for calculating a cutoff frequency and performing seismic sweeps in accordance with implementations of various techniques described herein.

FIG. 4 illustrates a graph of seismic data and harmonic noise in accordance with implementations of various techniques described herein.

FIG. 5 illustrates a graph of seismic sweeps in accordance with implementations of various techniques described herein.

FIG. 6 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

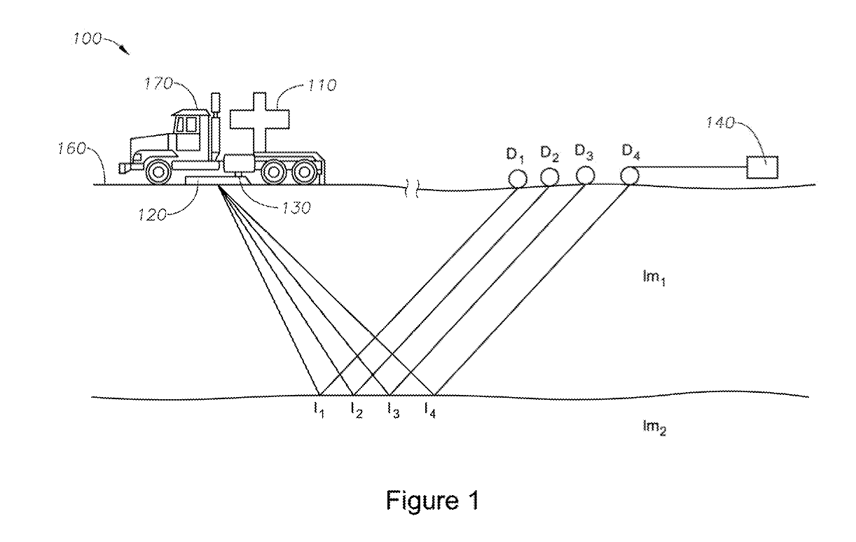

Various implementations described herein will now be described in more detail with reference to FIGS. 1-6.

FIG. 1 illustrates in a simplified manner the elements of a vibroseis acquisition system in connection with various implementations described herein. In the illustrated system, a seismic vibrator 100 includes a vibrating element 110, a baseplate 120 and a signal measuring apparatus 130, which may be for example, a plurality of accelerometers whose signals are combined to measure the actual ground-force signal applied to the earth by the seismic vibrator. The seismic vibrator 100 illustrated in FIG. 1 may be constructed on a truck 170 that provides for maneuverability of the system. As illustrated, the vibrating element 110 may be coupled with the baseplate 120 to provide for the transmission of vibrations from the vibrating element 110 to the baseplate 120. The baseplate 120 may be positioned in contact with an earth surface 160 and the vibrations of the vibrating element 110 may be communicated into the earth surface 160.

The seismic signal that is generated by the vibrating element 110 and emitted into the earth, via the baseplate 120, may be reflected off the interface between subsurface impedances Im1 and Im2 at points I1, I2, I3, and I4. This reflected signal may be detected by geophones D1, D2, D3, and D4, respectively. The signals generated by the vibrating element 110 on the truck 100 may also be transmitted to a data storage 140 for combination with raw seismic data received from geophones D1, D2, D3, and D4 to provide for processing of the raw seismic data. In operation, a control signal, referred to also as pilot sweep, causes the vibrating element 110 to exert a variable pressure on the baseplate 120.

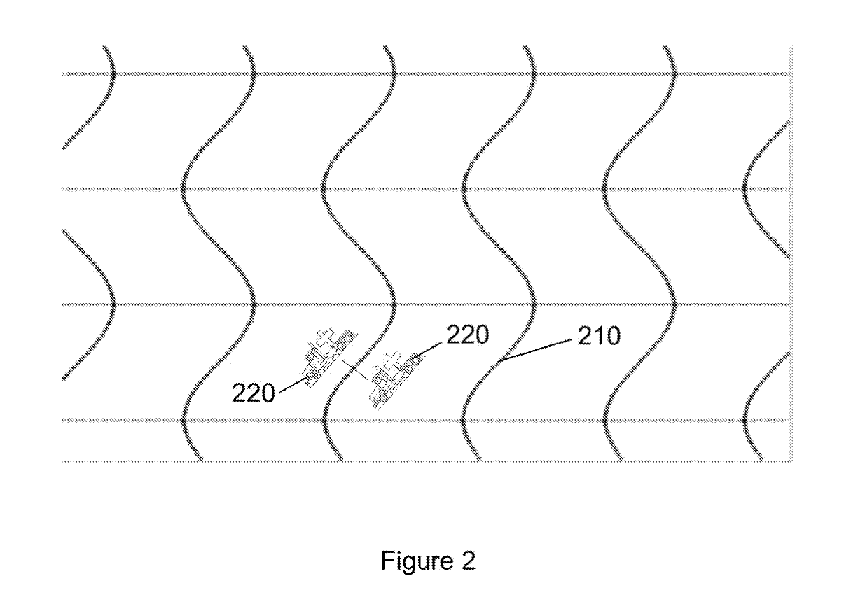

FIG. 2 illustrates a diagram of a seismic survey in connection with implementations of various techniques described herein. Source lines 210 may be areas where source locations are dense. The source lines 210 are illustrated as waves in FIG. 2, but they may be configured to any geometry, such as straight lines, or they may be drawn to avoid areas that are difficult or costly to survey. For example, if an area has vegetation or water, it may be more efficient to survey around that area.

Trucks 220 may include seismic sources used to conduct a seismic survey. In one implementation, the trucks 220 may be located on both sides of a source line 210, or in any location. The trucks 220 may be separated by a relatively small distance. In another implementation, the trucks 220 may be positioned orthogonally to a source line 210, as illustrated in FIG. 2. In yet another implementation, the trucks 220 may traverse the seismic source lines 210 in order to perform a seismic survey.

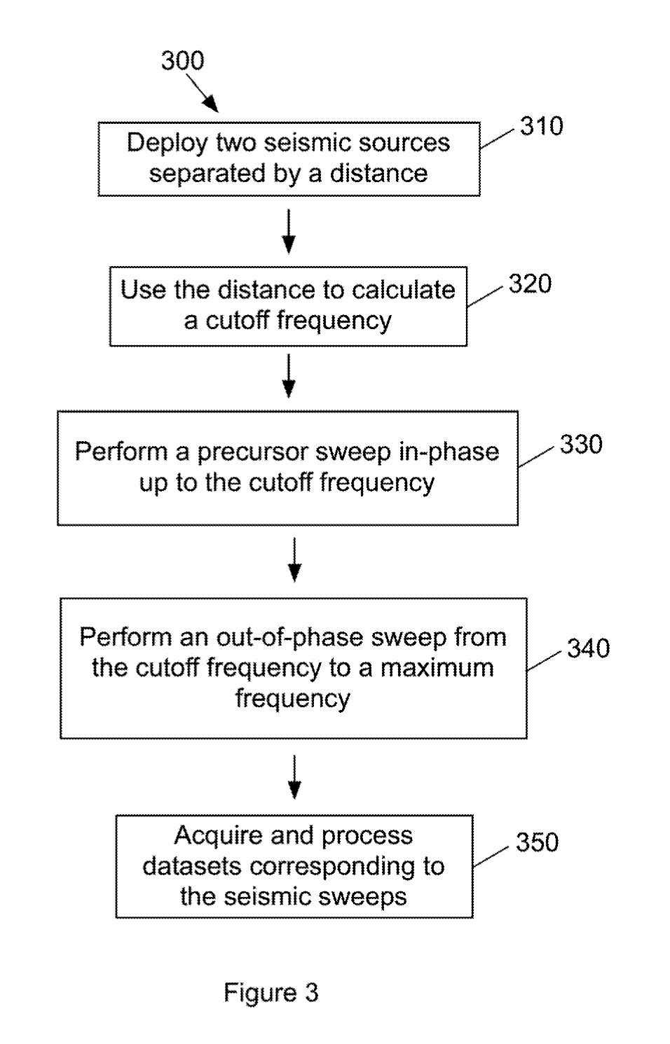

FIG. 3 is a flow diagram of a method 300 for calculating a cutoff frequency and performing seismic sweeps in accordance with implementations of various techniques described herein. In one implementation, method 300 may be performed by any computing device, such as computer 600, described below. It should be understood that while method 300 indicates a particular order of execution of operations, in some implementations, certain portions of the operations might be executed in a different order. Further, in some implementations, additional operations or steps may be added to method 300. Likewise, some operations or steps may be omitted. Additionally, the operations may be executed on more than one computer 600.

At block 310, two seismic sources may be deployed, where the seismic sources are separated by a predetermined distance. In one implementation, the predetermined distance may be between 12.5 meters and 25 meters. The sources may be deployed in a configuration similar to the survey illustrated in FIG. 2. The sources may be a vibroseis truck, as illustrated in FIG. 1. The sources may be positioned orthogonally on either side of a source line. The sources may be positioned on a source line.

In one implementation, more than two seismic sources may be deployed. For example, three sources may be deployed in an equilateral triangle formation. In another example, four sources may be deployed in a square formation.

At block 320, a cutoff frequency f_{c} may be calculated using the distance between the two seismic sources. The cutoff frequency may be calculated using the following equations:

$$\begin{matrix}{f}_{c} \geq \frac{{f}_{M}}{2} & Equation 1 \\ {T}_{L} ( {f}_{c} ) < {t}_{2} - {t}_{1} & Equation 2 \\ {f}_{c} < \frac{1}{2 π} \frac{{v}^{2} {t}_{0} \sqrt{1 + \frac{\overline{x}}{{v}^{2} {t}_{0}^{2}}}}{\overline{x} d} acos ( 2 {k}^{2} - 1 ) , 0 < k < 1 & Equation 3\end{matrix}$$

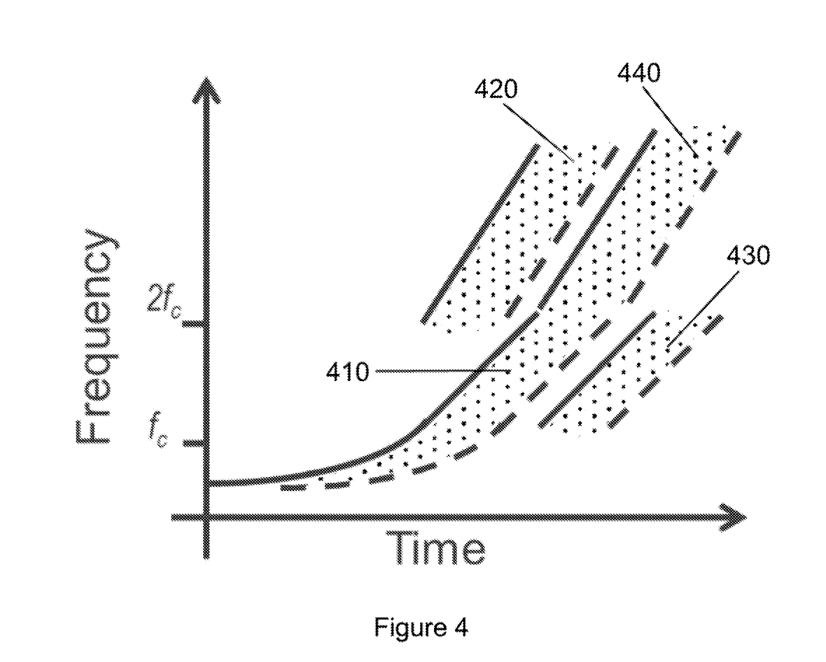

As described in Equations 1-3, the cutoff frequency f_{c} may be within a range of frequencies. Equation 1 may be used to determine the lower bound of the cutoff frequency. As stated in Equation 1, the cutoff frequency f_{c} may be greater than or equal to a maximum sweep frequency f_{M} divided by two. The maximum sweep frequency f_{M} may be selected by a user. A user may consider the target depth, geology, or other factors when determining a maximum sweep frequency f_{M}. By limiting the cutoff frequency to greater than or equal to half of the sweep maximum frequency, cascaded sweep harmonic energy may reside outside the sweep maximum frequency. This is further illustrated in FIG. 4.

Equation 2 defines a condition for the minimum duration of a cascaded sweep segment. T_{L} is the frequency dependent duration of the earth's response. The maximum of the frequency dependent duration of the earth's response T_{L} may be referred to as the listening time. The difference t₂−t₁ is the duration of the cascaded sweep segment. For example, in a 3 segment sweep, the total sweep length is 3*(t₂−t₁)

The upper bound of the cutoff frequency f_{c} is described in Equation 3. The normal moveout velocity of the reflections from the target horizons is labeled v. The two-way zero offset time is labeled t₀. x̅ is the offset from the midpoint of the two seismic sources to the considered receiver. d is the absolute value of the offset difference, and may be calculated using the formula d=|x₂−x₁|, where x₂ and x₁ are the offsets from the two seismic sources to the considered receiver.

The variable k may be a value selected within the range of zero to one. If the value selected for k is approximately one, only very low frequencies may be swept in-phase. Whereas, if the value selected for k is approximately zero, a broad range of frequencies may be swept simultaneously and in-phase. For example, a value of k=0.9 imposes that the cutoff frequency f_{c} is set such that the amplitude of the signal emitted simultaneously from two sources and recorded at a receiver with an offset x̅ is 90% higher than the amplitude of a signal emitted from a single source. The amplitude of the signals emitted simultaneously by two sources may be only 1−k times smaller than the amplitude of a signal emitted by a single source capable of emitting a signal with an amplitude that is twice that of the two sources.

In one implementation, if a seismic survey is designed and it is then determined that no cutoff frequency f_{c} may be found that satisfies both Equation 1 and Equation 3, the seismic survey may be redesigned in order to obtain a cutoff frequency f_{c} that satisfies both Equation 1 and Equation 3. For example, the distance d between sources may be reduced in order to satisfy both Equation 1 and Equation 3.

$$\begin{matrix}Δ t = \frac{\overline{x} d}{{t}_{0} {v}^{2} \sqrt{1 + \frac{\overline{x}}{{v}^{2} {t}_{0}^{2}}}} & Equation 4 \\ \vert 1 + {e}^{iϕ} \vert > 2 k , \\ ϕ = 2 π {f}_{c} Δ t & Equation 5 \\ \vert ϕ \vert < acos ( 2 {k}^{2} - 1 ) , 0 < k < 1 & Equation 6\end{matrix}$$

The traveltime difference for reflections from two sources is described in Equation 4. By setting the conditions described in Equation 5 on the amplitude of a signal simultaneously emitted from two sources, Equation 6 may be derived. Equation 3 may be derived by combining Equations 4 and 6.

Alternatively, a cutoff frequency f_{c} may be calculated as a function of a spatial wavenumber using the following equations:

$$\begin{matrix}F ( {k}_{x} ) = 1 + {e}^{- i2π {k}_{x} d} & Equation 7 \\ \vert f ( {k}_{x} ) \vert = 2 cos ( π {k}_{x} d ) & Equation 8 \\ {f}_{c} < \frac{{v}_{0}}{sin ( θ )} \frac{acos ( k )}{π d} & Equation 9\end{matrix}$$

Equation 7 corresponds to the array response of two contiguous sources in a wavenumber domain. The amplitude of the array response is described in Equation 8. Equation 9 may be used to determine the lower bound of the cutoff frequency f_{c} as a function of the apparent velocity v₀ and the factor k. During onshore acquisition, θ may be between ten and fifteen degrees.

At block 330, the seismic sources deployed at block 310 may perform a first seismic sweep. The first seismic sweep may be referred to as a precursor sweep. The precursor sweep may be a sweep where the two sources emit signals that are in-phase. In-phase signals are signals emitted by multiple sources simultaneously and with an identical phase. In one implementation, the first seismic sweep may be a relatively low frequency seismic sweep. For example, the low frequency seismic sweep may range from 20-40 Hertz. The first seismic sweep may be designed to reduce harmonic noise, further described below and in FIG. 4, from the seismic sources. The first seismic sweep may begin at a selected frequency and sweep up to a cutoff frequency f_{c} determined at block 320.

In one implementation, the precursor sweep may be modified during a seismic survey. For example, a first shot in a seismic survey may be performed with a first cutoff frequency f_{c} and have a precursor sweep ranging from a first initial frequency to the first cutoff frequency. The sources may then be moved to a new location, and a second shot may be performed with a second cutoff frequency f_{c}. The second shot may have a precursor sweep ranging from a second initial frequency to the second cutoff frequency. The first and second initial frequency may be equal. In this example, each individual shot is performed by two seismic sources, and the two seismic sources perform equivalent precursor sweeps during each individual shot.

At block 340, the seismic sources may perform a second sweep, where the sources emit signals that are out-of-phase. The second sweep may be at a higher frequency than the first sweep. The second sweep may be designed so that seismic source separation may be performed when processing the data in order to remove harmonic noise generated from the seismic sources. For example, phase encoding schemes that enable seismic source separation by creating orthogonal sequences may be used. Examples of phase encoding schemes that may be used are described in, among other sources, Ward et al., Phase Encoding of Vibroseis Signals for Simultaneous Multisource Acquisition, 1990 Society of Exploration of Geophysicists Meeting, Expanded Abstracts 938-41.

The second sweep may begin at a cutoff frequency f_{c} and sweep up to a maximum frequency f_{M}. The second sweep may have multiple segments. For example, the second sweep may be a cascaded sweep with three or four segments. The first and second seismic sweeps may be continuous. For example, there may be approximately zero lag time between the first and second sweep, or between seismic sweep segments.

At block 350, the response to the seismic sweeps may be acquired and processed. Datasets corresponding to signals from the first and second seismic sources may be recorded. Seismic source separation may be performed on the datasets. The disclosed method of an in-phase precursor sweep that emits energy up to frequency f_{c} reduces the effects of harmonic noise. In one implementation, seismic source separation may be performed on signals that correspond to the second sweep, but not on signals corresponding to the first sweep. The low frequency signals emitted in the first sweep do not require separation.

In one implementation, a gradient of a source wavefield may be obtained from a generated wavefield. For example, if the distance between two sources is smaller than the shortest wavelength, a wavefield may be obtained by phase shifting the sources. The phase shift may be applied after a precursor sweep is performed at block 330. The direction of the gradient may be the segment between the two sources. The criterion for the determination of the phase shift between two sources may be such that the shortest emitted wavelength is sampled at approximately one sixth of the wavelength. Emission of two signals with a π/3 phase shift may generate a composite signal at a receiver that approximates the spatial gradient.

FIG. 4 illustrates a graph of seismic data and harmonic noise in accordance with implementations of various techniques described herein. In FIG. 4, the earth's response to a three segment sweep performed by two seismic sources according to method 300 is illustrated. The first segment is a precursor sweep, which is swept in-phase, and the second and third segments are swept out-of-phase. The earth's response to the fundamental component of the first and second sweep segments is illustrated by area 410. The response to the second harmonic of the second segment of the cascaded sweep is illustrated by area 420.

The earth's response to the fundamental component of the third segment of the sweep is illustrated by area 430. The response to the second harmonic of the third segment of the cascaded sweep is illustrated by area 440.

Harmonic noise may be generated while performing a seismic sweep. The harmonic noise is a multiple of the desired frequency for the seismic signals. The harmonic noise may be generated by hydraulic systems used to create seismic signals. It may be desirable to remove harmonic noise, illustrated by areas 420 and 440, from the seismic data. As illustrated in FIG. 4, when performing method 300 the cascaded sweep harmonic energy, illustrated by areas 420 and 440, resides outside the sweep maximum frequency f_{M}, which, as described in Equation 1, is less than or equal to 2f_{c}. The method therefore reduces the effects of harmonic noise in cascaded sweeps.

In one implementation, the harmonic noise 420 and 440 from the second and third segments, which are performed out-of-phase, may be removed or reduced using seismic source separation. In this implementation, seismic source separation is not performed on the precursor segment, which is performed in-phase.

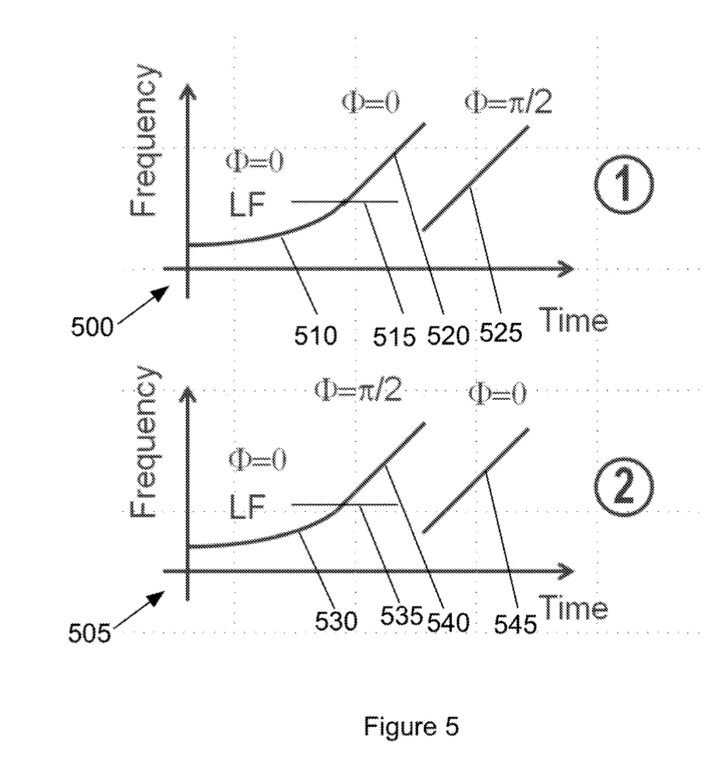

FIG. 5 illustrates a graph of seismic sweeps in accordance with implementations of various techniques described herein. The graphs illustrate a three segment seismic sweep performed by two seismic sources. Graph 500 corresponds to a first seismic source, and graph 505 corresponds to a second seismic source. The graphs 500 and 505 illustrate a time-frequency representation of two pre-compacted cascaded sweeps, each composed of three segments.

Segments 510 and 530 correspond to an in-phase precursor sweep. The precursor sweeps have an initial phase of zero. Segments 510 and 530 have equivalent frequencies and an equivalent phase and length, and are performed simultaneously by the two sources. Lines 515 and 535 illustrate the end of the precursor segments 510 and 530, and the beginning of the second segments 520 and 540. The segments 520 and 540 are performed out-of-phase. Segment 520 has an initial phase of zero, and segment 540 has an initial phase of π/2. The third segments, 525 and 545, are also performed out-of-phase. Segment 525 has an initial phase of π/2, and segment 545 has an initial phase of zero.

Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

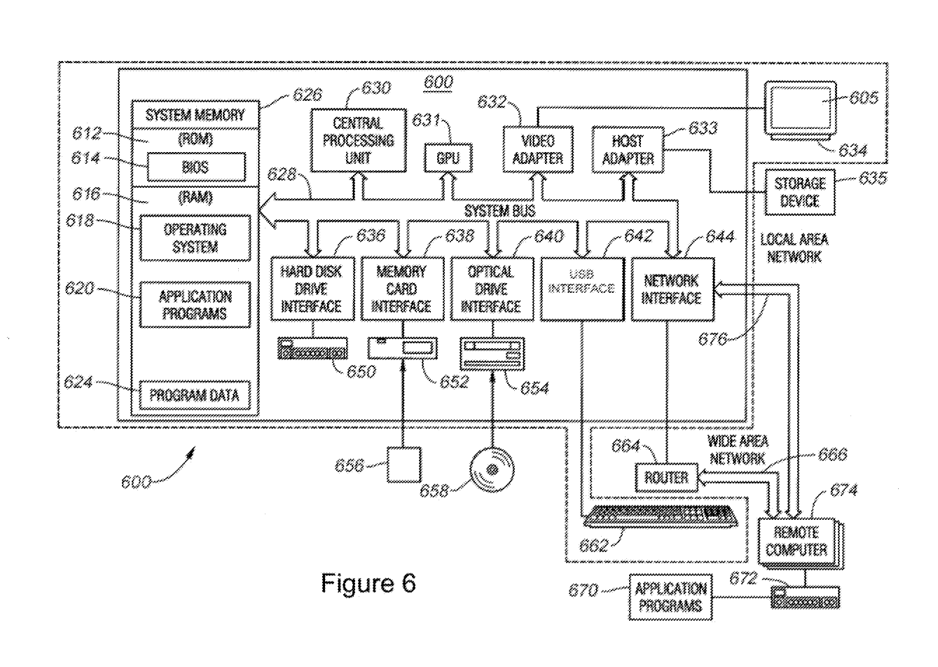

FIG. 6 illustrates a computer system 600 into which implementations of various technologies and techniques described herein may be implemented. Computing system 600 may be a conventional desktop, a handheld device, a wearable device, a controller, a server computer, an electronic device/instrument, a laptop, or a tablet. It should be noted, however, that other computer system configurations may be used.

The computing system 600 may include a central processing unit (CPU) 630, a system memory 626 and a system bus 628 that couples various system components including the system memory 626 to the CPU 630. Although only one CPU 630 is illustrated in FIG. 6, it should be understood that in some implementations the computing system 600 may include more than one CPU 630.

The CPU 630 can include a microprocessor, a microcontroller, a processor, a programmable integrated circuit, or a combination thereof. The CPU 630 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 630 may also include a proprietary processor. The CPU may include a multi-core processor.

The CPU 630 may provide output data to a Graphics Processing Unit (GPU) 631. The GPU 631 may generate graphical user interfaces that present the output data. The GPU 631 may also provide objects, such as menus, in the graphical user interface. A user may provide inputs by interacting with the objects. The GPU 631 may receive the inputs from interaction with the objects and provide the inputs to the CPU 630. In one implementation, the CPU 630 may perform the tasks of the GPU 631. A video adapter 632 may be provided to convert graphical data into signals for a monitor 634. The monitor 634 includes a screen 605. The screen 605 can be sensitive to heat or touching (now collectively referred to as a “touch screen”). In one implementation, the computer system 600 may not include a monitor 634.

The GPU 631 may be a microprocessor specifically designed to manipulate and implement computer graphics. The CPU 630 may offload work to the GPU 631. The GPU 631 may have its own graphics memory, and/or may have access to a portion of the system memory 626. As with the CPU 630, the GPU 631 may include one or more processing units, and each processing unit may include one or more cores.

The system bus 628 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 626 may include a read only memory (ROM) 612 and a random access memory (RAM) 616. A basic input/output system (BIOS) 614, containing the basic routines that help transfer information between elements within the computing system 600, such as during start-up, may be stored in the ROM 612. The computing system may be implemented using a printed circuit board containing various components including processing units, data storage memory, and connectors.

The computing system 600 may further include a hard disk drive 636 for reading from and writing to a hard disk 650, a memory card reader 652 for reading from and writing to a removable memory card 656 and an optical disk drive 654 for reading from and writing to a removable optical disk 658, such as a CD ROM, DVD ROM or other optical media. The hard disk drive 650, the memory card reader 652 and the optical disk drive 654 may be connected to the system bus 628 by a hard disk drive interface 636, a memory card interface 638 and an optical drive interface 640, respectively. The drives and their associated computer-readable media may provide nonvolatile storage of computer-readable instructions, data structures, program modules and other data for the computing system 600.

Although the computing system 600 is described herein as having a hard disk 650, a removable memory card 656 and a removable optical disk 658, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. The computing system 600 may also include a host adapter 633 that connects to a storage device 635 via a small computer system interface (SCSI) bus, a Fiber Channel bus, an eSATA bus, or using any other applicable computer bus interface. The computing system 600 can also be connected to a router 864 to establish a wide area network (WAN) 666 with one or more remote computers 674. The router 664 may be connected to the system bus 628 via a network interface 644. The remote computers 674 can also include hard disks 672 that store application programs 670.

In another implementation, the computing system 600 may also connect to one or more remote computers 674 via local area network (LAN) 676 or the WAN 666. When using a LAN networking environment, the computing system 600 may be connected to the LAN 676 through the network interface or adapter 644. The LAN 676 may be implemented via a wired connection or a wireless connection. The LAN 676 may be implemented using Wi-Fi technology, cellular technology, or any other implementation known to those skilled in the art. The network interface 644 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 674. It will be appreciated that the network connections shown are exemplary and other means of establishing a communications link between the computer systems may be used. The network interface 644 may also include digital cellular networks, Bluetooth, or any other wireless network interface.

A number of program modules may be stored on the hard disk 650, memory card 656, optical disk 658, ROM 612 or RAM 616, including an operating system 618, one or more application programs 620, program data 624 and a database system. The one or more application programs 620 may contain program instructions configured to perform method 300 according to various implementations described herein. The operating system 618 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 600 through input devices such as a keyboard 662 and pointing device. Other input devices may include a microphone, joystick, game pad, satellite dish, scanner, user input button, wearable device, or the like. These and other input devices may be connected to the CPU 630 through a USB interface 642 coupled to system bus 628, but may be connected by other interfaces, such as a parallel port, Bluetooth or a game port. A monitor 605 or other type of display device may also be connected to system bus 628 via an interface, such as a video adapter 632. In addition to the monitor 634, the computing system 600 may further include other peripheral output devices such as speakers and printers.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing a seismic survey operation, comprising:
deploying two seismic sources separated by a distance;
using the two seismic sources to simultaneously emit an in-phase first seismic sweep ranging from a minimum frequency to a cutoff frequency, wherein the cutoff frequency is calculated based on the distance; and
using the two seismic sources to simultaneously emit an out-of-phase second seismic sweep ranging from the cutoff frequency to a maximum frequency.

2. The method of claim 1, wherein the maximum frequency is less than or equal to twice the cutoff frequency.

3. The method of claim 1, wherein deploying two seismic sources comprises deploying two seismic sources orthogonally to a seismic source line.

4. The method of claim 1, wherein the cutoff frequency is less than
$$\frac{1}{2 π} \frac{{v}^{2} {t}_{0} \sqrt{1 + \frac{\overline{x}}{{v}^{2} {t}_{0}^{2}}}}{\overline{x} d} acos ( 2 {k}^{2} - 1 ) ,$$
where v is a normal moveout velocity of reflections, t₀ is a two-way zero offset time, x̅ is an offset from a midpoint of the two seismic sources to a considered receiver, d is an absolute value of an offset difference, and k is a selected value.

5. The method of claim 4, wherein k is selected to be a value between zero and one.

6. The method of claim 1, wherein using the two seismic sources to simultaneously emit an in-phase first seismic sweep ranging from the minimum frequency to the cutoff frequency comprises:
determining a lower bound and upper bound for the cutoff frequency; and
selecting a cutoff frequency greater than or equal to the lower bound and less than the upper bound.

7. The method of claim 1, further comprising:
acquiring a dataset corresponding to the emitted seismic sweeps; and
performing seismic source separation on data in the dataset corresponding to the second seismic sweep.

8. The method of claim 1, wherein the first seismic sweep comprises one sweep segment, and the second seismic sweep comprises a plurality of sweep segments.

9. The method of claim 1, wherein the first and second seismic sweeps are continuously swept.

10. The method of claim 1, further comprising generating a gradient of a source wavefield.

11. The method of claim 10, wherein generating a gradient of a source wavefield comprises phase shifting the two seismic sources.

12. A non-transitory computer-readable medium having stored thereon computer-executable instructions which, when executed by a computer, cause the computer to:
cause a first and second seismic vibrator to emit simultaneously an in-phase first seismic sweep ranging from a minimum frequency to a cutoff frequency;
cause the first and second seismic vibrator to emit simultaneously an out-of-phase second seismic sweep ranging from the cutoff frequency to a maximum frequency less than or equal to twice the cutoff frequency;
acquire a first dataset attributable to the first seismic vibrator;
acquire a second dataset attributable to the second seismic vibrator; and
process the first and second datasets.

13. The non-transitory computer-readable medium of claim 12, wherein the computer-executable instructions that cause the computer to process the first and second datasets comprise instructions that cause the computer to perform seismic source separation on data in the datasets corresponding to the second seismic sweep.

14. The non-transitory computer-readable medium of claim 12, wherein the first and second seismic vibrator are deployed orthogonally to a seismic source line.

15. The non-transitory computer-readable medium of claim 12, wherein the cutoff frequency is less than
$$\frac{1}{2 π} \frac{{v}^{2} {t}_{0} \sqrt{1 + \frac{\overline{x}}{{v}^{2} {t}_{0}^{2}}}}{\overline{x} d} acos ( 2 {k}^{2} - 1 ) ,$$
where v is a normal moveout velocity of reflections, t₀ is a two-way zero offset time, x̅ is an offset from a midpoint of the two seismic vibrators to a considered receiver, d is an absolute value of an offset difference, and k is a selected value.

16. A method of performing a seismic survey operation, comprising:
deploying two seismic sources;
using the two seismic sources to perform a simultaneous in-phase precursor sweep; and
using the two seismic sources to perform a simultaneous out-of-phase cascaded sweep.

17. The method of claim 16, wherein the in-phase precursor sweep has a cutoff frequency that is less than or equal to a minimum frequency of the out-of-phase cascaded sweep.

18. The method of claim 16, wherein the in-phase precursor sweep has a cutoff frequency greater than or equal to half of a maximum frequency of the out-of-phase cascaded sweep.

19. The method of claim 16, wherein the in-phase precursor sweep has a cutoff frequency calculated using a distance between the two seismic sources.

20. The method of claim 16, wherein deploying two seismic sources comprises deploying two seismic sources orthogonally to a seismic source line.
